(19) United States
(12) Patent Application Publication
(10) Pub. No.: US 2015/0039375 A1
(43) Pub. Date: Feb. 5, 2015

(54) SUPPLY CHAIN OPTIMIZATION METHOD AND SYSTEM

(71) Applicant: Caterpillar Inc., Peoria, IL (US)

(72) Inventors: Anthony James GRICHNIK, Eureka, IL (US); Thad Breton KERSH, Dunlap, IL (US); Frank Charles SOKOL, Metamora, IL (US); Duane Larry FIFER, Middletown, IL (US); Michael SESKIN, Cardiff, CA (US)

(73) Assignee: Caterpillar Inc., Peoria, IL (US)

(21) Appl. No.: 13/957,650

(22) Filed: Aug. 2, 2013

(51) Int. Cl. G06Q 10/06

(52) U.S. Cl. CPC G06Q 10/06313
USPC 705/7.23

(57) ABSTRACT

A computer-implemented method for managing a supply chain including a plurality of supply chain entities is disclosed. The method may include determining a plurality of input parameters for modeling the supply chain. Each input parameter has a plurality of input parameter values within a plausible range. The method may also include determining a plurality of candidate network structures, and determining a business goal value for each candidate network structure based on a plurality of possible input combinations of the input parameter values. The method may further include determining a statistical distribution of the business goal values for each network structure.

### TECHNICAL FIELD

This disclosure relates generally to systems and methods for supply chain optimization, and more particularly, to systems and methods for supply chain optimization by considering variable design parameters and tariff effects.

### BACKGROUND

Supply chain planning may be essential to the success of many of today's companies. Most companies may rely on supply chain planning to ensure the timely delivery of products in response to customer demands, such as to ensure the smooth functioning of different aspects of production, from the ready supply of components to meet production demands to the timely transportation of finished goods from the factory to the customer.

Modern supply chain planning may often include a wide range of variables, extending from distribution and production planning driven by customer orders, to materials and capacity requirements planning, to shop floor scheduling, manufacturing execution, and deployment of products. A vast array of data may be involved. To achieve successful supply chain planning, supply chain modeling may be used as a mathematical process tool to process and analyze the vast array of data and to determine various requirements of supply chain planning.

Certain techniques have been used to address supply chain modeling issues. For example, U.S. Patent Publication No. 2007/0150332, to Grichnik (the '332 publication), discloses a heuristic supply chain modeling method for modeling a supply chain entity. The method disclosed by the '332 publication includes obtaining an order fulfillment requirement for a product from a downstream supply chain entity and identifying one or more representative subsystems of the product. The method may also include determining a supply capacity and an inventory requirement for the supply chain entity with respect to the one or more representative subsystems, and calculating an inventory cost for the supply chain entity based on the inventory requirement with respect to the one or more representative subsystems.

The modeling method of the '332 publication only considers constant input parameters such as a constant order fulfillment requirement, or a constant shipping time between a supplier and a customer. In reality, these input parameter may constantly change. In addition, the modeling method of the '332 publication considers only one path and one shipping method between the supplier and the customer. However, there are often a number of different paths or shipping methods to affect shipment from the supplier to the customer, and the input parameters may change. Moreover, the modeling method of the '332 publication does not consider the effect of tariffs that might be incurred on the supply and the customer when they are located in different countries. Therefore, while the modeling method of the '332 publication has certain advantages, it may still be improved upon.

The supply chain management system of the present disclosure is directed toward solving the problem set forth above and/or other problems of the prior art.

### SUMMARY

In one aspect, the present disclosure is directed to a computer-implemented method for managing a supply chain including a plurality of supply chain entities. The method may include determining a plurality of input parameters for modeling the supply chain. Each input parameter has a plurality of input parameter values within a plausible range. The method may also include determining a plurality of candidate network structures, and determining a business goal value for each candidate network structure based on a plurality of possible input combinations of the input parameter values. The method may further include determining a statistical distribution of the business goal values for each network structure.

In another aspect, the present disclosure is directed to a computer-implemented method for managing a supply chain including a plurality of supply chain entities. The method may include determining a plurality of input parameters for modeling the supply chain. Each input parameter has an input parameter value. The method may also include determining at least one tariff cost imposed on a product. The method may further include determining a plurality of optimal network structures to achieve one or more of a plurality of desired business goals based on the input parameter values and the tariff cost, and determining a plurality of refined business goal values associated with each optimal network structure by considering tariff effects.

In yet another aspect, the present disclosure is directed to a computer-implemented method for managing a supply chain including a plurality of supply chain entities. The method may include: (a) determining a plurality of input parameters for modeling the supply chain, each input parameter having a plurality of input parameter values within a plausible input parameter value range; (b) determining a plurality of tariff costs imposed on a product and distributed within a plausible tariff cost range; (c) determining a plurality of desired business goals; (d) selecting an input combination consisting of a plurality of input parameter values and a tariff cost; (e) determining a plurality of optimal network structures to achieve the plurality of desired business goals based on the input combination, wherein each optimal network structure is determined to achieve a respective desired business goal; (f) determining, by the processor, a plurality of refined business goal values associated with each optimal network structure by considering tariff effects; (g) determining, for each desired business goal, whether a statistical distribution of the plurality of refined business goal values is stabilized; and (h) repeating steps (d)-(g) until the statistical distribution of all of the desired business goals are stabilized.

### BRIEF DESCRIPTION OF THE DRAWINGS

FIG. 1 is a schematic illustration of an exemplary supply chain in which the supply chain optimization system consistent with the disclosed embodiments may be implemented.

FIG. 2 is a schematic illustration of an exemplary supply chain optimization system consistent with certain disclosed embodiments.

FIG. 3 is a flow chart illustrating an exemplary process for supply chain optimization by considering variable inputs, consistent with a disclosed embodiment.

FIG. 4 is a histogram showing an exemplary statistical distribution of profit values associated with a network structure.

FIG. 5 is a flow chart illustrating an exemplary process for supply chain optimization by considering tariff effects, consistent with a disclosed embodiment.

FIG. 6 is a flow chart illustrating an exemplary process for determining an optimal network structure to achieve a desired business goal, consistent with a disclosed embodiment.

FIG. 7 is a flow chart illustrating an exemplary process for determining a plurality of refined business goal values associated with the optimal network structure, consistent with a disclosed embodiment.

FIG. 8 is a flow chart illustrating an exemplary process for supply chain optimization by considering the effects of multiple tariffs, consistent with a disclosed embodiment.

FIG. 9 is a graph showing the different refined profit values with respect to various tariff costs, obtained as an example consistent with a disclosed embodiment.

FIG. 10 is a graph showing the different refined profit values with respect to various tariff costs, obtained as another example consistent with the disclosed embodiment.

FIG. 11 is a flow chart illustrating an exemplary process for supply chain optimization by considering various input parameters and various tariff effects by using a stochastic modeling method, consistent with a disclosed embodiment.

FIG. 12 is a histogram showing a statistical distribution of refined profit values, obtained as an example consistent with a disclosed embodiment.

FIG. 13 is a histogram showing a statistical distribution of refined response times, obtained as another example consistent with the disclosed embodiment.

FIG. 14 is a flow chart illustrating an exemplary process for supply chain optimization by considering various input parameters and various tariff effects by using stochastic modeling method and Zeta statistic process, consistent with a disclosed embodiment.

### DETAILED DESCRIPTION

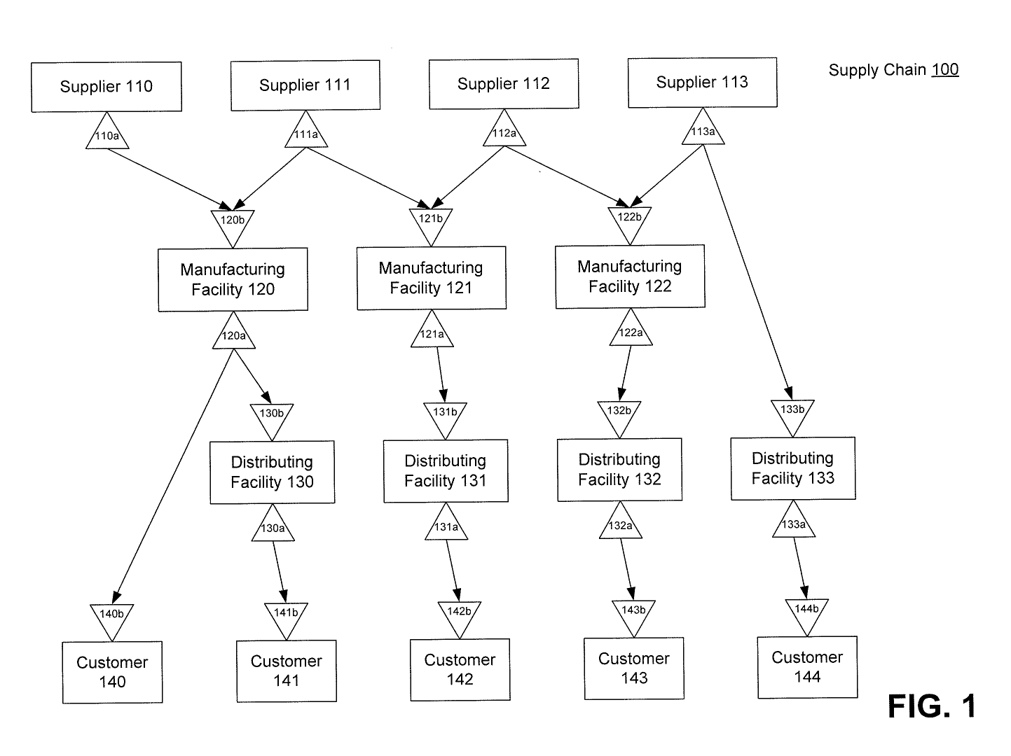

FIG. 1 illustrates an exemplary supply chain 100 in which the supply chain optimization system consistent with the disclosed embodiments may be implemented. As shown in FIG. 1, supply chain 100 may include a plurality of supply chain entities, such as suppliers 110-113, manufacturing facilities 120-122, distributing facilities 130-133, and customers 140-144.

Suppliers 110-113 may supply individual items to one or more of manufacturing facilities 120-122, one or more of distributing facilities 130-133, and one or more of customers 140-144. An item, as used herein, may represent any type of physical good that is designed, developed, manufactured, and/or delivered by supplier 110. Non-limiting examples of the items may include engines, tires, wheels, transmissions, pistons, rods, shafts, or any other suitable component of a product.

Manufacturing facilities 120-122 may manufacture or assemble products by using one or more individual items received from suppliers 110-113. A product, as used herein, may represent any type of finished good that is manufactured or assembled by a manufacturing facility. The product may include one or more components supplied from suppliers 110-113. Non-limiting examples of the products may include chemical products, mechanical products, pharmaceutical products, food, and fixed or mobile machines such as trucks, cranes, earth moving vehicles, mining vehicles, backhoes, material handling equipment, farming equipment, marine vessels, on-highway vehicles, or any other type of movable machine that operates in a work environment. The products manufactured by different manufacturing facilities 120-122 may be identical, or may be different from each other. Manufacturing facilities 120-122 may respectively deliver the manufactured products to one or more distributing facilities 130-133, or directly to one or more customers 140-144.

Distributing facilities 130-133 may store individual items received from one or more suppliers 110-113, and may distribute the individual items to customers 140-144 for sale as service or replacement parts for existing products. In addition, distributing facilities 130-133 may store manufactured products received from one or more manufacturing facilities 120-122, and may distribute the manufactured products to customers 140-144. In some embodiments, one of distributing facilities 130-133 may distribute the individual items or manufactured products to another one of distributing facilities 130-133, before the individual items or manufactured products are finally distributed to customers 140-144.

Although supply chain 100 shown in FIG. 1 includes four suppliers 110-113, three manufacturing facilities 120-122, four distributing facilities 130-133, and five customers 140-144, those skilled in the art will appreciate that supply chain 100 may include any number of suppliers, manufacturing facilities, distributing facilities, and dealers.

The supply chain entities in supply chain 100 may include upstream supply chain entities, such as suppliers 110-113, and downstream supply chain entities, such customers 140-144. In supply chain 100, items or products may flow in a direction from upstream supply chain entities to downstream supply chain entities. Inside each supply chain entity, at least one of a downstream inventory and an upstream inventory may be included. Downstream inventory 110a-133a may include inventories of products, parts, or subsystems that a supply chain entity may need to keep before the products, parts, or subsystems may be accepted by the supply chain entity's downstream supply chain entities. For example, manufacturing facility 120 may include a downstream inventory 120a of products before the products can be transported to and accepted by distributing facility 130.

On the other hand, upstream inventory 120b-144b may include inventories of products, parts, or subsystems that a supply chain entity receives from the supply chain entity's upstream supply chain entities and may need to keep before the products, parts, or subsystems may be used in manufacturing or other transactional processes. In the same example above, manufacturing facility 120 may also include a upstream inventory 120b of engines from supplier 110 before the work machines may be manufactured using the engines and other parts or subsystems. Further, similar to manufacturing facility 120, suppliers 110-113 may respectively include downstream inventories 110a-113a; manufacturing facilities 121 and 122 may respectively include downstream inventories 121a and 122a and upstream inventories 121b and 122b; distributing facilities 130-133 may respectively include downstream inventories 130a-133a and upstream inventories 130b-133b; and customers 140-144 may respectively include upstream inventories 140b-144b.

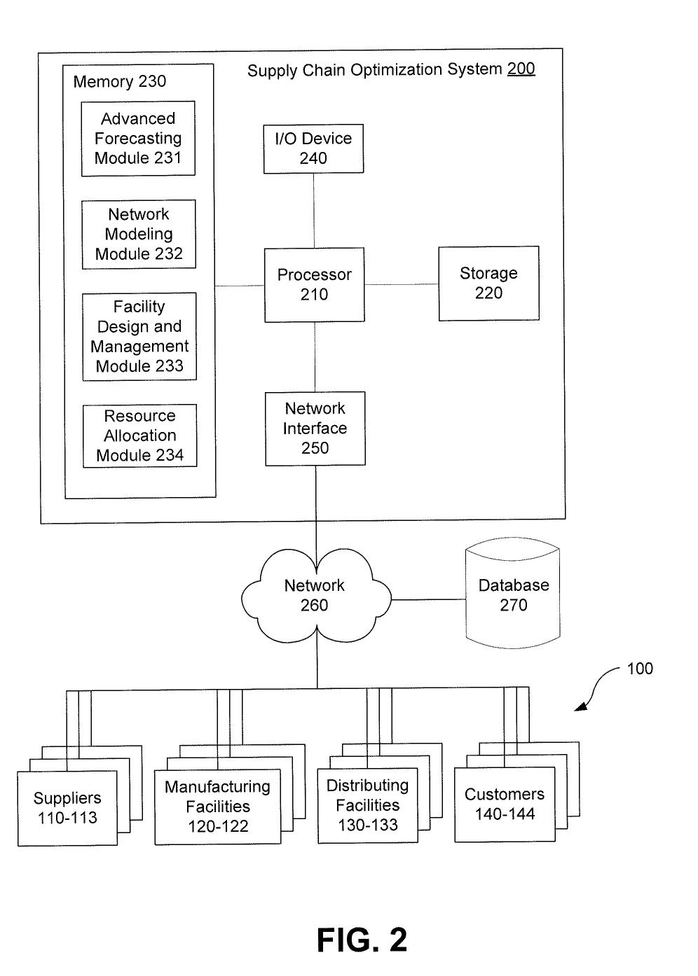

When customers 140-144 make demands to manufacturing facilities 120-122 or distributing facilities 130-133, the downstream inventories and upstream inventories listed above may be determined such that the demand can be fulfilled with minimum inventory cost and within the response time agreed between the customer and the company. The determination may be carried out according to disclosed embodiments by an exemplary system as shown in FIG. 2.

FIG. 2 illustrates an exemplary supply chain optimization system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as suppliers 110-113, manufacturing facilities 120-122, distributing facilities 130-133, and customers 140-144. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and method consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more items at any one of the supply chain entities based on historical data associated with the item. For example, advanced forecasting module 231 may forecast a future demand for an item at each one of manufacturing facilities 120-122 and distributing facilities 130-133 based on respective historical demand data for that item at manufacturing facilities 120-122 and distributing facilities 130-133. In addition, advanced forecasting module 231 may forecast the future demand for the item at suppliers 110-113 by combining the forecasted demand for the item at each one of manufacturing facilities 120-122 and distributing facilities 130-133.

Network modeling module 232 may receive the forecasted information from advanced forecasting module 231 and simulate and optimize the flow of materials (i.e., items, parts, products, etc.) between the supply chain entities in order to meet certain business goals of the entire organization that includes the supply chain entities. The business goal may include at least one of response time, profit, return on net assets, inventory turns, service level, and resilience. Network modeling module 232 may simulate the flow of materials based on geographical locations of each one of the supply chain entities, the transportation methods (e.g., air, ship, truck, etc.), and link capacities (e.g., quantity of materials that can be transported via a certain route). Based on the simulation results and other information such as production costs, transportation costs, and regional sales price, and the like, network modeling module 232 may generate information such as gross revenue, cost of goods sold, and profit related to one or more products or parts.

Facility design and management module 233 may receive the forecasted information from advanced forecasting module 231 and the simulation results from network modeling module 232 and may determine the physical structure and dimension of one or more of manufacturing facilities 120-122 and distributing facilities 130-133 based on the received information. For example, facility design and management module 233 may receive forecasted information representing quantity of the incoming items to be received at manufacturing facilities 120-122 and distributing facilities 130-133. Based on this forecasted information, facility design and management module 233 may determine dimensions and locations of shelving, racks, aisles, and the like, of manufacturing facilities 120-122 and distributing facilities 130-133. Facility design and management module 233 may also determine the location of incoming items within manufacturing facilities 120-122 and distributing facilities 130-133, based on the forecasted information. Moreover, facility design and management module 233 may simulate the movement of resources (e.g., workers, machines, transportation vehicles, etc.) throughout manufacturing facilities 120-122 and distributing facilities 130-133 over time. Still further, facility design and management module 233 may modify input information in order to achieve one or more of the business goals.

Resource allocation module 234 may receive availability data representing the quantity of one or more items that are available at suppliers 110-113. When the availability data is less than the forecasted demand data of the item at suppliers 110-113, resource allocation module 234 may allocate the available items at manufacturing facilities 120-122, distributing facilities 130-133, and customers 140-144 in order to achieve one or more of the business goals associated with the entire organization.

I/O device 240 may include one or more components configured to communication information associated with system 200. For example, I/O device 240 may include a console with an integrated keyboard and mouse to allow a user to input parameters associated with system 200 and/or data associated with supply chain 100. I/O device 240 may include one or more displays or other peripheral devices, such as, for example, printers, cameras, microphones, speaker systems, electronic tablets, bar code readers, scanners, or any other suitable type of I/O device 240.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with logistics network management.

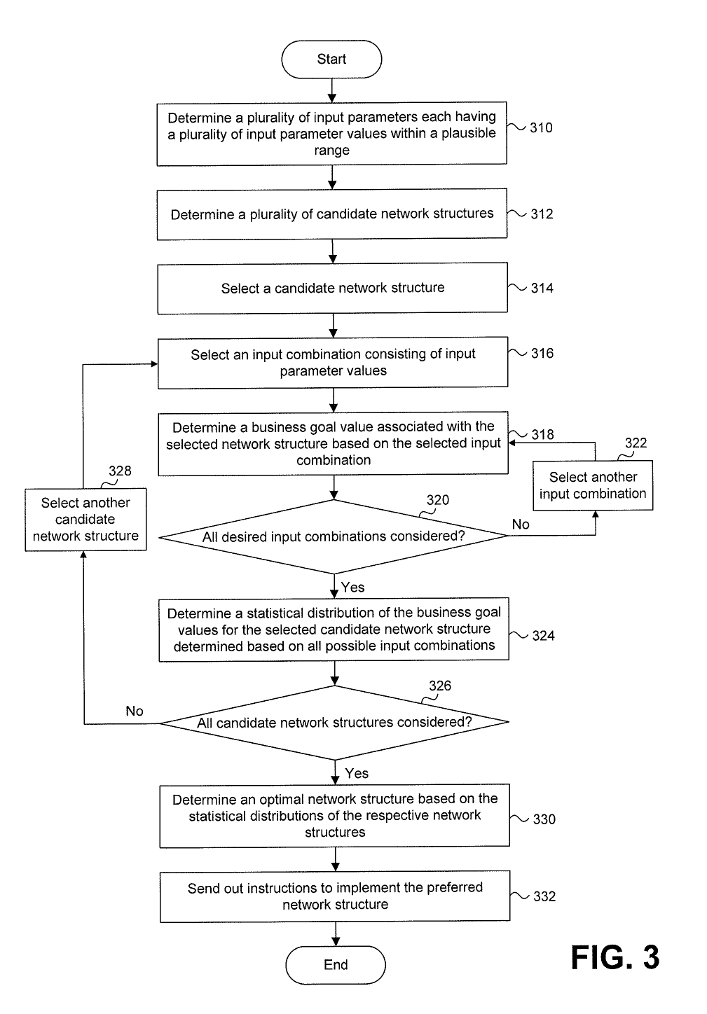

FIG. 3 is a flow chart illustrating an exemplary process for supply chain optimization by considering variable inputs, consistent with a disclosed embodiment. According to FIG. 3, processor 210 may first determine a plurality of input parameters for modeling supply chain 100 (step 310). Each input parameter may have a plurality of input parameter values within a plausible range. Examples of the input parameter may include at least one of source availability data, demand data, sales prices, processing time, shipping time, material costs, energy cost, and transportation costs. The input parameters and their respective values may be determined based on inputs from one or more users of system 200. Alternatively, processor 210 may determine the various input parameters and their respective values automatically based on data from database 270 and/or based on data from other computer systems performing related tasks.

Next, processor 210 may determine a plurality of candidate network structures of supply chain 100 (step 312). Each network structure defines a transportation route and a transportation method between each one of the supply chain entities. An exemplary candidate network structure of supply chain 100 is shown in FIG. 1. For example, as shown in FIG. 1, suppliers 110 and 111 supply parts to manufacturing facility 120, which then manufactures a product from the parts, and delivers the manufactured product to customer 140. Alternatively, in another exemplary candidate network structure, manufacturing facility 120 may deliver the manufactured product to distributing facility 130, which may then deliver the manufactured product to customer 140. Still alternatively, customer 140 may directly receive a manufactured product from manufacturing facility 121, or indirectly receive the manufactured product from manufacturing facility 121 via distributing facility 131.

After determining the plurality of candidate network structures at step 312, processor 210 may determine a business goal value for each candidate structure based on each possible input combination of the input parameter values. Specifically, processor 210 may first select a candidate network structure from the plurality of candidate network structures (step 314). Processor 210 may also select an input combination consisting of input parameter values (step 316). In the input combination, each input parameter has a respective input parameter value selected from the plurality of input parameter values determined in step 310. Then, processor 210 may determine the business goal value associated with the selected candidate structure based on the selected input combination (step 318).

In one exemplary embodiment, a business organization has a desired business goal of generating maximum profit. In this case, processor 210 may determine a profit value associated with the selected candidate network structure. The profit value P may be represented by:

P=[(# of products sold)×(profit margin per product sold)]−total transportation cost of all connections in the supply chain network−total inventory cost at all locations in the supply chain network.

In order to calculate the profit value P, processor 210 may determine the total transportation cost as a sum of transportation costs along individual paths in the selected network structure. Processor 210 may also determine the total inventory cost by determining an inventory requirement for each supply chain entity based on the input combination, determining an inventory cost for each supply chain entity based on the respective inventory requirement, and determining the total inventory cost by combining the respective inventory cost for each supply chain entity.

After determining the business goal value associated with the selected candidate structure based on the selected input combination at step 318, processor 210 may determine whether all of the desired input combinations have been considered (step 320). For example, the desired input combinations may be different permutations of the input parameter values requested by a user of system 200. If they have not (step 320: No), processor 210 may select another input combination (step 322). Then processor 210 may repeat steps 318, 320, and 322 until all of the desired input combinations have been considered. For example, in the next input combination, the shipping time for shipping products between manufacturing facility 120 and distributing facility 130 changes from 30 days to 40 days. This may change the total transportation cost for the products, which may in turn change the profit value. For another example, in the next input combination, the processing time for manufacturing product in manufacturing facility 120 changes from 1 day to 2 days. This may change the inventory requirement for upstream inventory 120 of manufacturing facility 120, which may in turn change the total inventory cost and the profit value.

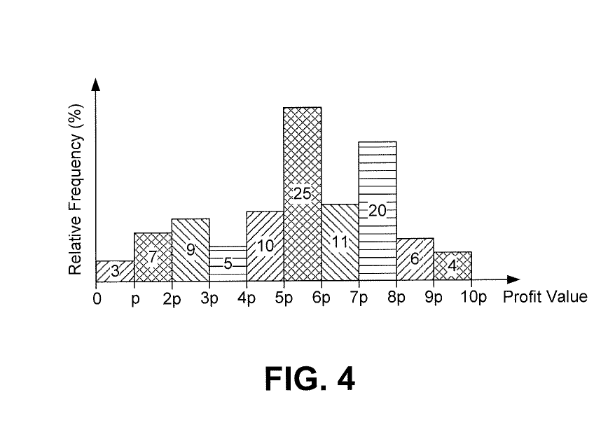

If all of the desired input combinations have been considered (step 320: Yes), processor 210 may determine a statistical distribution of the business goal values for the selected candidate network structure determined based on all desired input combinations (step 324). FIG. 4 is a histogram showing an exemplary statistical distribution of profit values. The X-axis of FIG. 4 represents the profit values of p, 2p, 3p, . . . and 10p, wherein p may be any value. The Y-axis of FIG. 4 represents the frequency of the observation of the profit values in the intervals between 0 and p, p and 2p, . . . and 9p and 10p. For example, according to FIG. 4, 25% of the profit values determined based on all possible input combinations fall between the profit values of 5p and 6p. For another example, 6% of the profit values determined based on all possible input combinations fall between the profit values of 8p and 9p.

Referring back to FIG. 3, processor 210 may determine a statistical distribution of the business goal values for each candidate network structure. Specifically, after determining the statistical distribution of the business goal values for the selected candidate network at step 324, processor 210 may determine whether all of the candidate network structures have been considered (step 326). If not (step 326: No), processor 210 may select another candidate network structure (step 328). Then processor 210 may repeat steps 316 through 328 until all of the candidate network structures have been considered (step 326: Yes).

After determining the statistical distributions of the business goal values for each of the respective candidate network structures, processor 210 may determine an optimal network structure based on the statistical distributions (step 330). In one embodiment, processor 210 may select a candidate network structure having a maximum percentage of all input combinations that produce business goal values that are greater than or equal to a threshold business goal value. For example, in the statistical distribution of a first candidate network structure shown in FIG. 4, 66% of all input combinations produce profit values that are greater than or equal to a threshold profit value of 5p. In this example, based on a statistical distribution of a second candidate network structure, processor 210 may also determine that only 40% of all input combinations produce profit values that are greater than or equal to 5p. Then, processor 210 may select the first candidate network structure as the optimal network structure. In another embodiment, processor 210 may instruct a display device to display all of the candidate network structures and their respective statistical distributions. Then, a user of system 200 may select an optimal network structure based on the display. After determining the optimal network structure, processor 210 may send out instructions to the supply chain entities to implement the optimal network structure (step 332).

In certain embodiments, system 200 may optimize supply chain 100 by considering the effects of one or more tariffs. A tariff is generally a tax imposed by custom authorities on international imports or exports. In order to avoid unnecessary tariff costs between a supply chain entity in one country and a supply chain entity in another country, a free trade zone may be established in intermediate path locations between the supply chain entities, if the two countries have agreed to reduce or eliminate trade barriers. For example, in FIG. 1, manufacturing facility 120 may be located in country A, distributing facility 130 may be located in country B, and customer 141 may be located in country C. If trade barrier exists between country A and country C, an additional tariff cost will be imposed on all of the products supplied from manufacturing facility 120 to customer 141. If country A and country C have agreed to eliminate trade barriers, then even if there is a trade barrier between country A and country B or between country B and country C, a bonded warehouse may be established in distributing facility 130, where products incoming from manufacturing facility 120 may be received, handled, and exported to customer 141, such that the tariff cost may be minimized. Therefore, the existence of tariffs may not only affect the cost of a product, but also affect the shipping time, operation cost, and inventory cost of the bonded warehouse.

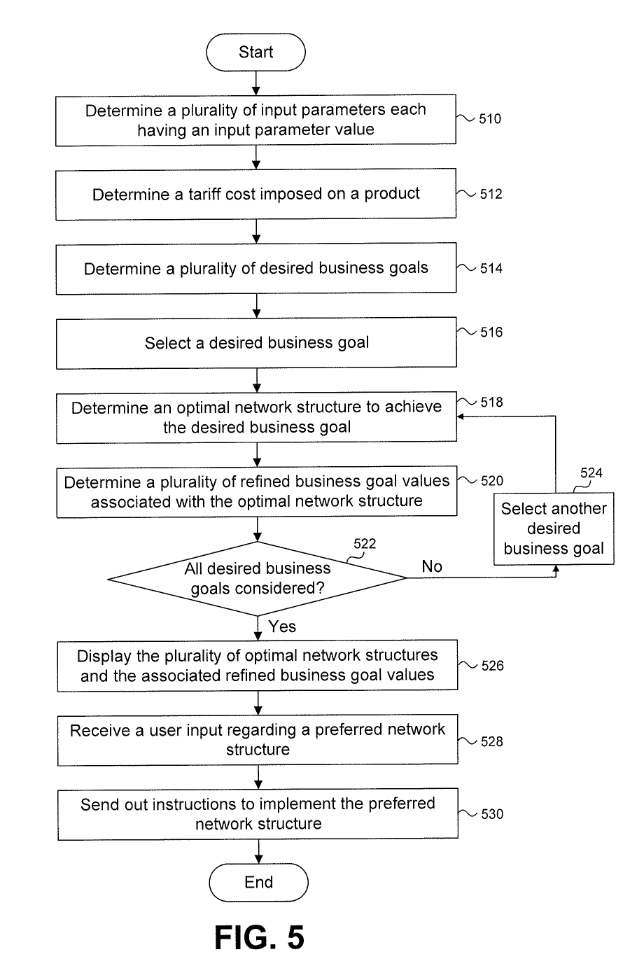

FIG. 5 is a flow chart illustrating an exemplary process for supply chain optimization by considering tariff effects, consistent with a disclosed embodiment. According to FIG. 5, processor 210 may first determine a plurality of input parameters for modeling supply chain 100 (step 510). Each input parameter may have an input parameter value. Next, processor 210 may determine at least one tariff cost imposed on a product supplied from one supply chain entity to another supply chain entity (step 512). For example, processor 210 may determine a tariff cost imposed on a manufactured product supplied from manufacturing facility 120 to customer 141, as shown in FIG. 1. As discussed above, processor 210 may determine the input parameter values and the tariff cost based on user inputs, or based on data from database 270.

Then, processor 210 may determine a plurality of desired business goals (step 514). Examples of the desired business goals may include minimizing response time, maximizing profit, maximizing return on net assets, minimizing inventory cost, maximizing inventory turns, maximizing service level, and maximizing a resilience of the supply chain. The resilience of a supply chain may be defined as the percentage of a resulting business goal at risk should any one of the supply chain entities perform at less than their expected performance value or fail completely. For example, referring to FIG. 1, when all of the supply chain entities in supply chain 100 perform at their respective expected performance value, supply chain 100 may generate a profit P1. When manufacturing facility 121 fails, it is not possible to supply product to customer 142. Then, supply chain 100 may only generate a profit P2. Then, the resilience of supply chain 100 may be defined as:

Resilience=P2/P1.

Afterwards, processor 210 may determine a plurality of optimal network structures to achieve the plurality of desired business goals based on the input parameter values and the tariff cost. Specifically, processor 210 may select a first desired business goal (step 516). Next, processor 210 may determine an optimal network structure to achieve the desired business goal (step 518).

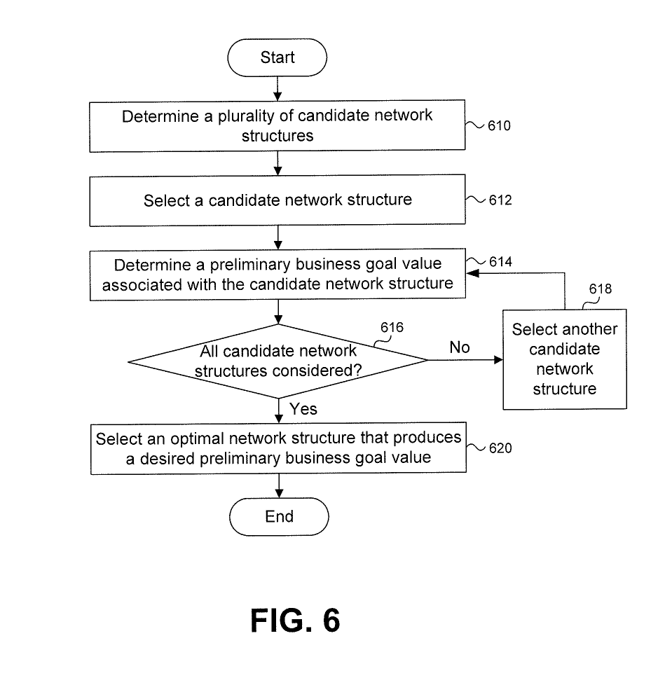

FIG. 6 is a flow chart illustrating an exemplary process for determining an optimal network structure to achieve a desired business goal that may be performed as a part of step 518. First, processor 210 may determine a plurality of candidate network structures (step 610). An exemplary candidate network structure of supply chain 100 is shown in FIG. 1. Next, processor 210 may select a candidate network structure (step 612), and determine a preliminary business goal value of the desired business goal associated with the candidate network structure by considering only the tariff cost (step 614). For example, if a desired business goal is to maximize profit, processor 210 may determine a preliminary profit value of the selected candidate network structure by considering the tariff cost. In this step, the effects of tariff on shipping time, operational cost, and inventory cost, etc., are ignored. The preliminary profit value P_{preliminary} may be represented by:

P_{preliminary}=[(# of products sold)×(profit margin per product sold)−total transportation cost−total inventory cost]−[(# of products sold)×(tariff cost per product sold)]

After determining the preliminary business goal value associated with the candidate network structure in step 614, processor 210 may determine whether all of the candidate network structures have been considered (step 616). If not all of the candidate network structures have been considered (step 616: No), processor may select another candidate network structure (step 618). Then processor may repeat steps 614, 616, and 618 until all of the candidate network structures have been considered.

Afterwards, processor 210 may select an optimal network structure that produces a desired preliminary business goal value (step 620). For example, processor 210 may select an optimal network structure that produces a maximum preliminary profit value compared to the other candidate network structures.

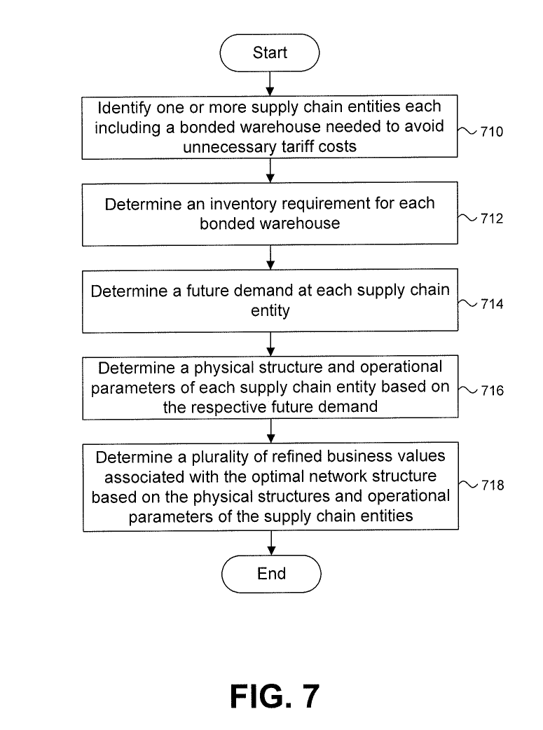

Referring back to FIG. 5, after determining an optimal network structure to achieve the desired business goal in step 518, processor 210 may determine a plurality of refined business goal values associated with the optimal network structure by considering the tariff effects (step 520). FIG. 7 is a flow chart illustrating an exemplary process for determining a plurality of refined business goal values associated with the optimal network structure that may be performed as a part of step 520. Processor 210 may first identify one or more supply chain entities each including a bonded warehouse needed to avoid unnecessary tariff costs (step 710). In the above-discussed example related to FIG. 1, when manufacturing facility 120 is located in country A, distributing facility 130 is located in country B, and customer 141 is located in country C, and when country A and country C have agreed to eliminate trade barriers, then a bonded warehouse may be established in distributing facility 130 to avoid unnecessary tariff costs. Processor 210 may identify the location of the bonded warehouses based on current tariff rules stored in database 270.

Next, processor 210 may determine an inventory requirement for each bonded warehouse included in the supply chain entities (step 712). For example, processor 210 may determine the inventory requirement based on the demand data and the supply data as the input parameters determined in step 510. Processor 210 may determine a future demand at each supply chain entity (step 714). For example, processor 210 may forecast future demand at each supply chain entity based on the respective historical demand data and one or more respective business goals for each supply chain entity. Processor 210 may also determine a shipping time delay along each path in the candidate network structure. Processor 210 may then adjust the future demand at each supply chain entity by compensating for the shipping time delay. Processor 210 may combine, for each supply chain entity, the respective adjusted future demand data of each downstream supply chain entity to generate combined future demand at the supply chain entity.

After determining the future demand at each supply chain entity in step 714, processor 210 may determine a physical structure and operational parameters of each supply chain entity based on the respective future demand (step 716). For example, processor 210 may determine the physical structures and operational costs to accommodate the incoming products in order to optimize floor space, locations, and operational parameters. Finally, processor 210 may determine a plurality of refined business values associated with the optimal network structure (step 718). For example, processor 210 may determine an operational cost of each supply chain entity, and then combine the operational costs of all of the supply chain entities included in supply chain 100 to determine a total operation cost of supply chain 100. Then, processor 210 may determine a refined profit value P_{refined} represented by:

P_{refined}=[(# of products sold)×(profit margin per product sold)−total transportation cost−total inventory cost]−[(# of products sold)×(tariff cost per product sold)]−total operation cost.

In addition to the refined profit value, processor 210 may determine other refined business goal values such as response time, resilience, service level, etc., associated with the optimal network structures.

Referring back to FIG. 5, after determining the plurality of refined business goal values associated with the optimal network structure in step 520, processor 210 may determine whether all of the desired business goals have been considered (step 522). When not all of the desired business goals have been considered (step 522: No), processor 210 may select next desired business goal from among the plurality of desired business goals (step 524). Then, processor 210 may repeat steps 518 through 524 until all of the desired business goals have been considered (step 522: Yes).

Afterwards, processor 210 may instruct a display device to display the plurality of optimal network structures and the associated refined business goal values (step 526). Based on the display, a user of system 200 may select a preferred network structure from among the plurality of optimal network structures. Then, processor 210 may receive the user input regarding the preferred network structure (step 528). Finally, processor 210 may send out instructions to the supply chain entities to implement the preferred network structure (step 530).

Although the tariff cost in the above exemplary embodiment is imposed on a product supplied from a supply chain entity to another supply chain entity, those skilled in the art will appreciate that the tariff cost may be imposed on one or more products, and/or one or more parts, and/or one or more items. In addition, those skilled in the art will appreciate that amount of the tariff cost is regulated by the local rules or laws of a source supply chain entity and a destination supply chain entity, and is irrelevant to the intermediate supply chain entities between the source and the destination provided free trade agreements allow “pass through” privileges for the entities and countries in question.

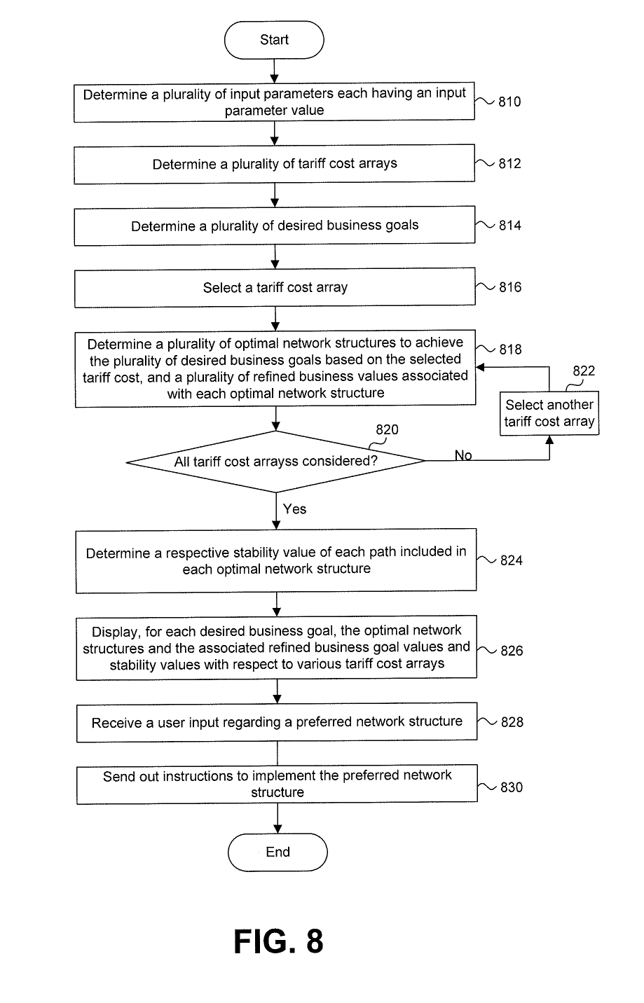

FIG. 8 is a flow chart illustrating an exemplary process for supply chain optimization by considering the effects of multiple tariffs, consistent with a disclosed embodiment. According to FIG. 8, processor 210 may first determine a plurality of input parameters each having an input parameter value (step 810). Next, processor 210 may determine a plurality of tariff cost arrays (step 812). Each tariff cost array includes a plurality of possible tariff cost values each being imposed on a product supplied from one supply chain entity to another supply chain entity. For example, processor 210 may evenly distribute the possible tariff cost values for the corresponding product within a plausible range. For example, a first product A supplied from manufacturing facility 120 to customer 141 may be imposed with tariff cost values t_{A1}, t_{A2}, . . . t_{An}, evenly distributed with a first range, and a second product B supplied from manufacturing facility 121 to customer 142 may be imposed with tariff cost values t_{B1}, t_{B2}, . . . t_{Bn}, evenly distributed with a second range. In such case, processor 210 may determine a plurality of tariff cost arrays [t_{A1}, t_{B1}], [t_{A2}, t_{B1}], [t_{A3}, t_{B1}], [t_{A2}, t_{B2}], . . . [t_{An}, t_{Bn}]. Then, processor 210 may determine a plurality of desired business goals (step 814).

Afterwards, processor 210 may determine a plurality of optimal network structures based on each tariff cost. Specifically, processor 210 may first select a tariff cost array from the plurality of tariff cost arrays (step 816). Then, processor 210 may determine the plurality of optimal network structures to achieve the plurality of business goals based on the selected tariff cost, and may determine a plurality of refined business values associated with each optimal network structure based on the selected tariff cost array (step 818). Each optimal network structure is determined to achieve a respective desired business goal based on the selected tariff cost array. Processor 210 may perform step 818 by performing steps 516-524 illustrated in FIG. 5, for example. Therefore, detailed operation of step 818 is omitted.

In some embodiments, due to the complexity of computation involved in the determining of the optimal network structures and the associated refined business goal values in step 818, system 200 may use task parallelization for performing step 818. That is, system 200 may include a plurality of processors 210, and each processor 210 may perform step 818 for a respective desired business goal. For example, a first processor may determine a plurality of optimal network structures to maximize profit and may calculate a plurality of refined business goal values for each optimal network structure, and a second processor may determine a plurality of optimal network structures to minimize response time and may calculate a plurality of refined business goal values for each optimal network structure. Then, a central processor or either one of the first processor and the second processor may combine the data obtained from each one of the first processor and the second processor, and may perform the following data processing steps.

After determining the plurality of optimal network structure based on the selected tariff cost array in step 818, processor 210 may determine whether all of the tariff cost arrays have been considered (step 820). When not all of the tariff cost arrays have been considered (step 820: No), processor 210 may select another tariff cost array (step 822). Then, processor 210 may repeat steps 818 through 822 until all of the tariff cost arrays have been considered (step 820: Yes).

Afterwards, processor 210 may determine a respective stability value of each path included in each optimal network structure (step 824). In one embodiment, the stability value may be represented by the number of times, or the frequency with which, a particular path appears in the plurality of optimal network structures. For example, processor 210 may determine 10 optimal network structures, and may found that the path between manufacturing facility 120 and distributing facility 130 repeatedly appears in 8 of the 10 optimal network structures. Then, processor 210 may determine that the stability value of the path between manufacturing facility 120 and distributing facility 130 is 80%.

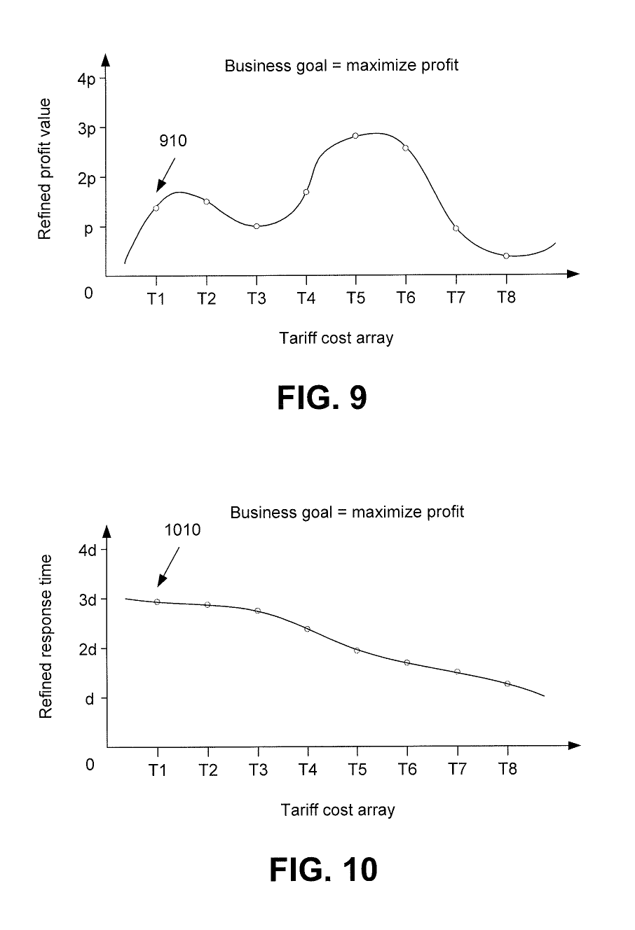

After determining the respective stability value of each path included in each optimal network structure in step 824, processor 210 may instruct a display device to display, for each desired business goal, the optimal network structures and the associated refined business goal values and stability values with respect to various tariff cost arrays (step 826). For example, when the desired business goal is to maximize profit, the display device may display the plurality of optimal network structures determined to maximize profit based on various tariff cost arrays. The display device may display different optimal network structures in different colors. The display device may also highlight the paths that are common to all of the optimal network structures. The display device may further display the respective stability value of each path in the optimal network structures. In addition, the display device may display a graph showing the different refined profit values with respect to various tariff costs. FIGS. 9 and 10 are examples of such graphs. In FIG. 9, data point 910 represents the refined profit value associated with an optimal network structure determined to maximize profit and based on a tariff cost array of T1. In FIG. 10, data point 1010 represents the refined response time associated with the optimal network structure determined to maximize profit and based on a tariff cost array of T1.

Referring back to FIG. 8, after step 826, a user may select a preferred network structure based on the display. The user may select one of the plurality of optimal network structures as the preferred network structure. Alternatively, the user may configure a preferred network structure based on the display by mixing different paths included in different network structures. Then, processor 210 may receive a user input regarding the preferred network structure (step 828). Finally, processor 210 may send out instructions to the supply chain entities to implement the preferred network structure (step 830).

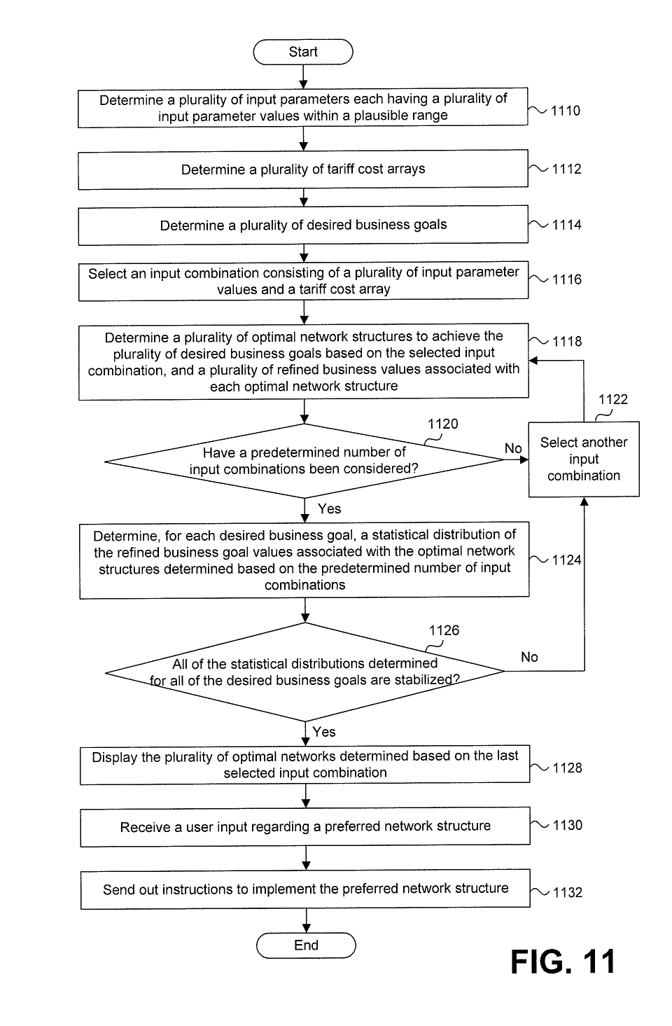

FIG. 11 is a flow chart illustrating an exemplary process for supply chain optimization by considering various input parameters and various tariff effects by using a stochastic modeling method, consistent with a disclosed embodiment. According to FIG. 11, processor 210 may first determine a plurality of input parameters each having a plurality of input parameter values within a plausible range (step 1110). Next, processor 210 may determine a plurality of tariff cost arrays (step 1112). Each tariff cost array includes a plurality of possible tariff cost values each being imposed on a product supplied from one supply chain entity to another supply chain entity. The plurality of possible tariff cost values for the corresponding product may be evenly distributed within a plausible range. Then, processor 210 may determine a plurality of desired business goals (step 1114).

Afterwards, processor 210 may select an input combination consisting of a plurality of input parameter values and a tariff cost array (step 1116). Each input parameter value within the input combination corresponds to a respective input parameter and is selected from the plurality of input parameter values within the respective plausible range. The tariff cost array within the input combination is selected from the plurality of tariff cost arrays. Processor 210 may select an input combination by using a Monte Carlo sampling method or a Latin Hypercube sampling method, for example.

After selecting the input combination in step 1116, processor 210 may determine a plurality of optimal network structures to achieve the plurality of desired business goals based on the selected input combination, and a plurality of refined business values associated with each optimal network structure (step 1118). Each optimal network structure is determined to achieve a respective desired business goal based on the selected input combination. Processor 210 may perform step 1118 by performing steps 516-524 illustrated in FIG. 5, for example. Therefore, detailed operation of step 1118 is omitted.

After determining the plurality of optimal network structures based on the selected input combination in step 1118, processor 210 may determine whether a predetermined number of input combinations have been considered (step 1120). When the predetermined number of input combinations have not been considered (step 1120: No), processor 210 may select another input combination (step 1122). Processor 210 may repeat steps 1118 through 1122 until the predetermined number of input combinations have been considered (step 1120: Yes).

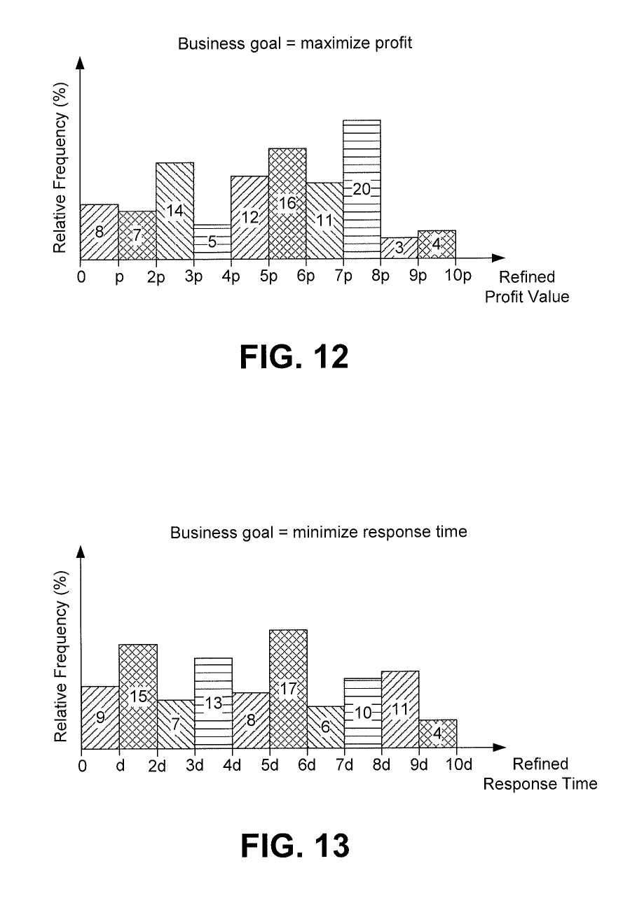

Afterwards, processor 210 may determine, for each desired business goal, a statistical distribution of the refined business goal values associated with the optimal network structures determined based on the predetermined number of input combinations (step 1124). FIGS. 12 and 13 are examples of such statistical distributions. In FIG. 12, a predetermined number, for example, 1000, of optimal network structures are determined to maximize profit, based on a respective one of the predetermined number of input combinations. FIG. 12 is histogram showing a statistical distribution of the refined profit values associated with these predetermined number of optimal network structures. According to FIG. 12, for example, 16% of the optimal network structures have the refined profit values between 5p and 6p; and 20% of the optimal network structures have the refined profit values from 7p to 8p. Similarly, in FIG. 13, a predetermined number, for example, 1000, of optimal network structures are determined to minimize response time, based on a respective one of the predetermined number of input combinations. FIG. 13 is histogram showing a statistical distribution of the refined response times associated with these predetermined number of optimal network structures.

Referring back to FIG. 11, after step 1124, processor 210 may determine whether all of the statistical distributions determined for all of the desired business goals are stabilized (step 1126). In one embodiment, processor 210 performs step 1126 by using the Anderson Darling statistic for two distributions. For example, processor 210 may compare, for each desired business goal, a statistical distribution determined based on N input combinations with a statistical distribution determined based on (N−1) input combinations, and determine whether a the difference between the two statistical distributions is within an acceptable range relative to the Anderson Darling statistic.

When processor 210 determines that not all of the statistical distributions for all of the desired business goals are stabilized (step 1126: No), processor 210 may select another input combination (step 1122). Then, processor 210 may repeat steps 1118 through 1126 until all of the statistical distributions are stabilized (step 1126: Yes).

Afterwards, processor 210 may instruct a display device to display the plurality of optimal networks determined based on the last selected input combination (step 1128). Then, processor 210 may receive a user input regarding a preferred network structure (step 1130). Finally, processor 210 may send out instructions to the supply chain entities to implement the preferred network structure (step 1132).

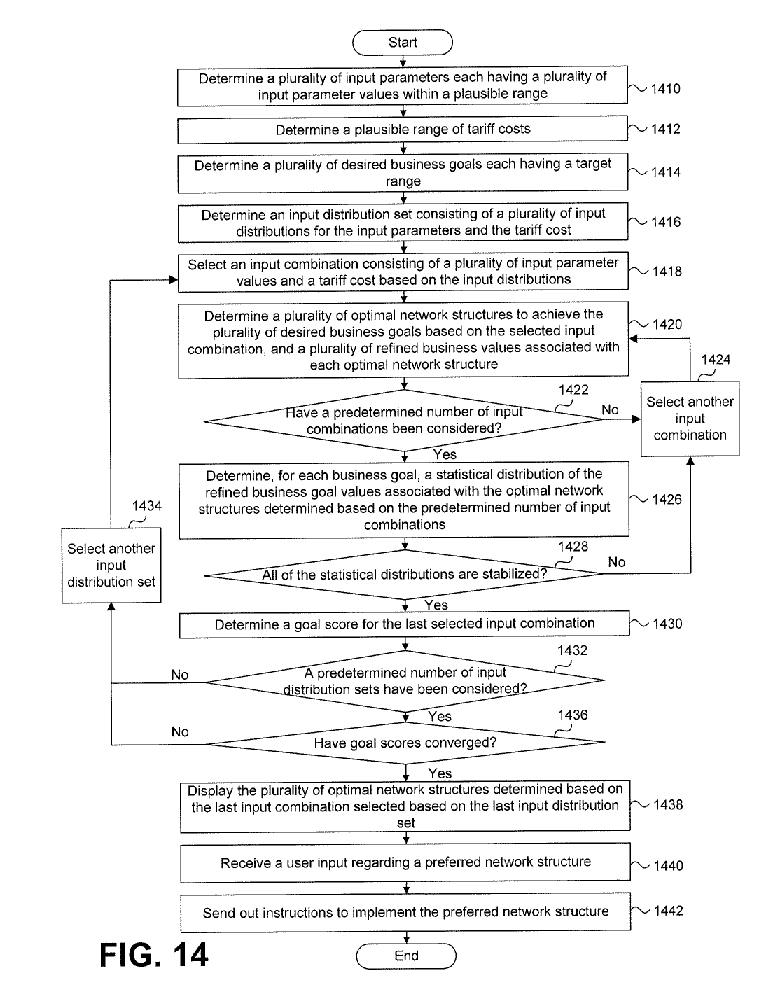

FIG. 14 is a flow chart illustrating an exemplary process for supply chain optimization by considering various input parameters and various tariff effects by using the described stochastic modeling method and combined with a Zeta statistic process, consistent with a disclosed embodiment. According to FIG. 14, processor 210 may first determine a plurality of input parameters each having a plausible range (step 1410). Next, processor 210 may determine a plausible range of tariff costs imposed on a product supplied from one supply chain entity from another supply chain entity (step 1412). Then, processor 210 may determine a plurality of desired business goals (step 1414).

Afterwards, processor 210 may determine an input distribution set consisting of a plurality of input distributions corresponding to the input parameters and the tariff cost (step 1416). That is, each input parameter has a respective input distribution, and the tariff cost has an input distribution. Examples of the input distribution may include a triangular distribution, a Gaussian distribution, etc. There are two types of input parameters: controllable input parameters and uncontrollable input parameters. Controllable input parameters are those that can be controlled by administrators of the business organization. Examples of the controllable input parameters include processing time, sales price, etc. Uncontrollable input parameters are those that cannot be controlled by the administrators. Examples of the incontrollable input parameters include shipping time effects due to weather, energy prices, etc.

After determining the input distributions in step 1416, processor 210 may select an input combination consisting of a plurality of input parameter values and a tariff costs based on the input distributions included in the input distribution set (step 1418). Each input parameter value within the input combination corresponds to a respective input parameter and is selected based on the respective input distribution. Similarly, the tariff cost within the input combination is selected based on the distribution of the tariff cost.

After selecting the input combination in step 1418, processor 210 may determine a plurality of optimal network structures to achieve the plurality of desired business goals based on the selected input combination, and a plurality of refined business values associated with each optimal network structure (step 1420). Each optimal network structure is determined to achieve a respective desired business goal based on the selected input combination. Processor 210 may perform step 1420 by performing steps 516-524 illustrated in FIG. 5, for example. Therefore, detailed operation of step 1420 is omitted.

After determining the plurality of optimal network structures based on the selected tariff costs in step 1420, processor 210 may determine whether a predetermined number of input combinations have been considered (step 1422). When the predetermined number of input combinations have not been considered (step 1422: No), processor 210 may select another input combination (step 1424). Processor 210 may repeat steps 1420 through 1424 until the predetermined number of input combinations have been considered (step 1422: Yes).

Afterwards, processor 210 may determine, for each desired business goal, a statistical distribution of the refined business goal values associated with the optimal network structures determined based on the predetermined number of input combinations (step 1426). Then, processor 210 may determine whether all of the statistical distributions determined for all of the desired business goals are stabilized (step 1428). When processor 210 determines that not all of the statistical distributions for all of the desired business goals are stabilized (step 1428: No), processor 210 may select another input combination (step 1424). Then, processor 210 may repeat steps 1420 through 1428 until all of the statistical distributions are stabilized (step 1126: Yes).

Then, processor 210 may determine a goal score for the last selected input combination based on the corresponding input distribution and the target ranges of the desired business goals (step 1430). A goal score of an input combination is a product of a Zeta statistic value of the input combination and a capability statistic value of the input combination. The Zeta statistic value ζ is represented by:

$$ζ = {\sum }_{1}^{j} {\sum }_{1}^{i} \vert {S}_{ij} \vert ( \frac{{σ}_{i}}{\overline{{x}_{i}}} ) ( \frac{\overline{{y}_{j}}}{{σ}_{j}} )$$

wherein x̅ᵢ̅ represents a mean of an ith input parameter within the corresponding input distribution; y̅ⱼ̅ represents a mean of a jth refined business goal value associated with the optimal network structure determined to achieve the jth desired business goal based on the input combination; σᵢ represents a standard deviation of the ith input parameter within the corresponding input distribution; σⱼ represents a standard deviation of the jth refined business goal value; and |Sᵢⱼ| represents sensitivity of the jth refined business goal value with respect to the ith input parameter. The capability statistic value of the input distribution set is represented by:

$${C}_{pk} = min \{ \frac{USL - \overline{{y}_{j}}}{3 {σ}_{j}} , \frac{\overline{{y}_{j}} - LSL}{3 {σ}_{j}} \}$$

wherein USL and LSL represent the upper and lower limits of the target range of the jth desired business goal.

After determining the goal score for the last selected input combination in step 1430, processor 210 may determine whether a predetermined number of input distribution sets have been considered (step 1432). When the determined number of input distribution sets have not been considered (step 1432: No), processor 210 may select another input distribution set (step 1434). In one embodiment, processor 210 may select the other input distribution set by adjusting the input distributions of the controllable input parameters. Then, processor 210 may repeat steps 1418 through step 1434 until the predetermined number of input distribution sets have been considered (step 1432: Yes).

Afterwards, processor 210 may determine whether the goal scores of the last selected input combination in the predetermined number of input distribution sets have converged (step 1436). In one embodiment, processor 210 may determine that the goal scores have converged when the goal scores have been maximized according to (ζ*the lowest Cₚₖ value across the multiple business goals).

When the goal scores have not converged (step 1436: No), processor 210 may select another input distribution set (step 1434). Then, processor 210 may repeat steps 1418 through 1436 until the goal scores have converged (step 1436: Yes). Afterwards, processor 210 may instruct a display device to display the plurality of optimal network structures determined based on the last input combination selected based on the last input distribution set (step 1438). Then, processor 210 may receive a user input regarding a preferred network structure (step 1440). Finally, processor 210 may send out instructions to the supply chain entities to implement the preferred network structure (step 1442).

### INDUSTRIAL APPLICABILITY

The disclosed supply chain optimization system 200 may efficiently provide optimized supply chain designs for any business organization to achieve one or more desired business goals. Based on the disclosed system and methods, effects of variable input parameters and variable tariff costs may be analyzed, and the robustness, efficiency, and accuracy of the supply chain designs may be significantly improved.

It will be apparent to those skilled in the art that various modifications and variations can be made to the disclosed supply chain optimization system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A computer-implemented method for managing a supply chain including a plurality of supply chain entities, the method comprising:
determining a plurality of input parameters for modeling the supply chain, each input parameter having a plurality of input parameter values within a plausible range;
determining, by a processor, a plurality of candidate network structures;
determining, by the processor, a business goal value for each candidate network structure based on a plurality of possible input combinations of the input parameter values; and
determining a statistical distribution of the business goal values for each network structure.

2. The method of claim 1, further including:
receiving, by the processor, a user input regarding a preferred network structure from among the plurality of candidate network structures.

3. The method of claim 1, further including:
selecting an optimal network structure from among the plurality of candidate network structures based on the statistical distributions of the business goal values for the candidate network structures.

4. The method of claim 1, further including determining a total inventory cost for each candidate structure based on a plurality of possible input combinations of the input parameter values that includes:
determining, for a candidate network structure, an inventory requirement for each supply chain entity based on an input combination;
determining an inventory cost for each supply chain entity based on the respective inventory requirement; and
determining the total inventory cost by combining the respective inventory costs for each supply chain entity.

5. A computer-implemented method for managing a supply chain including a plurality of supply chain entities, the method comprising:
(a) determining a plurality of input parameters for modeling the supply chain, each input parameter having an input parameter value;
(b) determining at least one tariff cost imposed on a product;
(c) determining, by a processor, a plurality of optimal network structures to achieve one or more of a plurality of desired business goals based on the input parameter values and the tariff cost; and
(d) determining, by the processor, a plurality of refined business goal values associated with each optimal network structure by considering tariff effects.

6. The method of claim 5, further including:
determining a plurality of tariff costs imposed on the product;
repeating steps (c) and (d) for each tariff cost; and
instructing a display device to display, for each desired business goal, the plurality of optimal network structures and the associated refined business goal values determined based on each of the plurality of tariff costs.

7. The method of claim 6, wherein each optimal network structure includes a plurality of transportation routes, the method further including:
determining a respective stability value associated with each path included in each optimal network structure; and
instructing the display device to display the plurality of stability values associated with the optimal network structures.

8. The method of claim 5, wherein step (c) includes:
determining a plurality of candidate network structures;
determining, for each candidate network structure, a preliminary business goal value based on the input parameter values and the tariff cost; and
selecting the optimal network structure from among the plurality of candidate network structures that produces a desired preliminary business goal value.

9. The method of claim 5, wherein step (d) includes:
identifying one or more supply chain entities each including a bonded warehouse for minimizing tariff costs;
determining an inventory requirement for each bonded warehouse;
determining a future demand at each supply chain entity;
determining a physical structure and operational parameters for each supply chain entity based on the future demand; and
determining the plurality of refined business values based on the physical structure and the operational parameters for each supply chain entity.

10. The method of claim 9, wherein the determining the future demand at each one of the supply chain entities includes:
forecasting future demand at each supply chain entity based on the respective historical demand data and one or more respective business goals for each supply chain entity;
determining a shipping time delay along each path in the candidate network structure;
adjusting the future demand at each supply chain entity by compensating for the shipping time delay; and
combining, for each supply chain entity, the respective adjusted future demand data of each downstream supply chain entity to generate combined future demand at the supply chain entity.

11. The method of claim 5, further including:
receiving a user input regarding a preferred network structure selected from the plurality of optimal network structures.

12. The method of claim 5, further including:
receiving a user input regarding a preferred network structure, wherein the preferred network structure is configured by the user based on the display of the plurality of optimal network structures and the associated refined business goal values.

13. The method of claim 5, further including instructing the display device to highlighting paths that are common to all of the plurality of optimal network structures.

14. The method of claim 5, wherein the input parameters include at least one of source availability data, demand data, sales prices, material costs, energy cost, and transportation costs.

15. The method of claim 5, wherein the business goals include at least one of response time, profit, return on net assets, inventory cost, inventory turns, service level, and resilience.

16. A computer-implemented method for managing a supply chain including a plurality of supply chain entities, the method comprising:
(a) determining a plurality of input parameters for modeling the supply chain, each input parameter having a plurality of input parameter values within a plausible input parameter value range;
(b) determining a plurality of tariff costs imposed on a product and distributed within a plausible tariff cost range;
(c) determining a plurality of desired business goals;
(d) selecting an input combination consisting of a plurality of input parameter values and a tariff cost;
(e) determining, by a processor, a plurality of optimal network structures to achieve the plurality of desired business goals based on the input combination, wherein each optimal network structure is determined to achieve a respective desired business goal;
(f) determining, by the processor, a plurality of refined business goal values associated with each optimal network structure by considering tariff effects;
(g) determining, for each desired business goal, whether a statistical distribution of the plurality of refined business goal values is stabilized; and
(h) repeating steps (d)-(g) until the statistical distribution of all of the desired business goals are stabilized.

17. The method of claim 16, further including, after step (c) and before step (d):
(c1) determining, for each input parameter and the tariff cost, an input distribution within the respective plausible input distribution and tariff cost range; and
(c2) determining a target range of each desired business goal,
wherein, in step (d), the input combination is selected based on the input distributions.

18. The method of claim 17, further including, after step (h), the steps of:
(i) determining a goal score for each input combination based on the respective input distributions and the target ranges of the desired business goals;
(j) determining whether the goal scores are converged;
(k) repeating steps (a1), (a2), and (b)-(j) until the goal scores are converged; and
(l) instructing a display device to display, for each desired business goal, the optimal network structure and the associated refined business goal values determined based on the last selected input combination.

19. The method of claim 18, wherein the goal score of the input combination is a product of a Zeta statistic value of the input combination and a capability statistic value of the input combination,
the Zeta statistic value is represented by:
$$ζ = {\sum }_{1}^{j} {\sum }_{1}^{i} \vert {S}_{ij} \vert ( \frac{{σ}_{i}}{\overline{{x}_{i}}} ) ( \frac{\overline{{y}_{j}}}{{σ}_{j}} )$$
wherein x̅ᵢ̅ represents a mean of an ith input parameter within the corresponding input distribution; y̅ⱼ̅ represents a mean of a jth refined business goal value associated with the optimal network structure determined to achieve the jth desired business goal based on the input combination; σᵢ represents a standard deviation of the ith input parameter within the corresponding input distribution; σⱼ represents a standard deviation of the jth refined business goal value; and |Sᵢⱼ| represents sensitivity of the jth refined business goal value with respect to the ith input parameter, and
the capability statistic value is represented by:
$${C}_{pk} = min \{ \frac{USL - \overline{{y}_{j}}}{3 {σ}_{j}} , \frac{\overline{{y}_{j}} - LSL}{3 {σ}_{j}} \}$$
wherein USL and LSL represent the upper and lower limits of the target range of the jth business goal,
wherein step (j) of determining whether the goal scores are converged is performed by determining whether the goal scores have been maximized according to (ζ*the lowest Cₚₖ value across the multiple business goals).

20. The method of claim 16, wherein step (d) is performed based on Monte Carlo sampling method or Latin Hypercube sampling method.
